(19) United States
(12) Patent Application Publication
(10) Pub. No.: US 2011/0234587 A1
(43) Pub. Date: Sep. 29, 2011

(54) METHOD AND SYSTEM FOR RENDERING OR INTERACTIVE LIGHTING OF A COMPLEX THREE DIMENSIONAL SCENE

(75) Inventors: Erwan Maigret, Ceyreste (FR); Arnauld Lamorlette, Fuveau (FR)

(73) Assignee: THE BAKERY, GEMENOS (FR)

(21) Appl. No.: 13/120,719

(22) PCT Filed: Sep. 24, 2009
(86) PCT No.: PCT/IB2009/007248

§ 371 Date: Apr. 14, 2011

Related U.S. Application Data
(60) Provisional application No. 61/099,685, filed on Sep. 24, 2008.

(51) Int. Cl. G06T 15/00

(52) U.S. Cl. 345/419

(57) ABSTRACT

The present invention concerns a method for rendering or interactive lighting of a tridimensional scene (35) in order to obtain a twodimensional image (12) of said scene comprising the steps of performing a shading process (15) taking into account a set of shader and material properties of the 3D objects of the scene wherein the shading process produces a shader frame-buffer (24) used to store information records related to shaders (20) and/or material properties (19) of the tridimensional scene (35) in a format where said information records can be accessed in relation with a an image position (x, y, sx, sy) in the twodimensional image (12).

### BACKGROUND OF THE INVENTION

The present invention concerns a method for rendering a three dimensional scene.

The process of producing three dimensional (3D) computer generated images for short or feature animation movies involves a step called lighting. The lighting phase consists of defining a lighting scenario that is aimed to illuminate a 3D representation of a scene made of 3D geometries with material properties that describe how the geometry of a given scene reacts to light. The lighter is the person responsible for defining this lighting scenario. The lighter work consists of an iterative process of changing parameters to a lighting scenario in order to achieve the artistic goal of generating a beautiful image. At each step of modification of a parameter, the lighter needs to see the result of the modification on the final image to evaluate the effect of such modification.

Lighting complex 3D images requires processing of very complex 3D geometries with very sophisticated representations to obtain the desired “artistic” result. Lighting a 3D scene correctly requires a great amount of time and manual labor due to the complex interactions of the various materials in the 3D scene, the amount of reflectivity of the materials and the position of one or more light sources.

One of the bottlenecks for processing large 3D scenes is the amount of complex geometric calculations that must be performed. The current algorithms used for rendering complex images usually require computer processing times ranging from several minutes for a simple 3D image to many hours. Advantageously, computing power cost less and less. Disadvantageously, the skilled labor to create the 3D images costs more and more.

The current standard process to light a 3D scene is that a few parameters of the 3D scene (such as, for example, light, texture, and material properties) are changed and then the work is rendered by one or more computers. However, the rendering process can take minutes or many hours before the results of the changes are able to be reviewed.

Further, if the 3D scene is not correct, the process must be repeated.

Known techniques to improve the time needed for rendering includes using dedicated hardware components as described in document U.S. Pat. No. 7,427,986.

Alternatively, document U.S. Pat. No. 7,532,212 describes a method aiming at a limitation of the amount of data to be loaded in memory.

The purpose of the present invention is to further improve the lighting productivity and artistic control when producing 3D computer generated images without the disadvantages of the known methods.

### SUMMARY OF THE INVENTION

The present invention concerns a method for rendering or interactive lighting of a tridimensional scene in order to obtain a twodimensional image of said scene comprising the steps of performing a shading process taking into account a set of shader and material properties of the 3D objects of the scene wherein the shading process produces a shader framebuffer used to store information records related to shaders and/or material properties of the tridimensional scene in a format where said information records can be accessed in relation with a an image position in the twodimensional image.

The present invention overcomes limitations of the prior art by providing a method to improve the lighting productivity and artistic control when producing 3D computer generated images.

The geometry fragments are represented by an array of value that depends only of the size of the final image independently from the initial geometry complexity using a deep file approach. The framebuffer file approach is applied to a re-lighting application to make it more efficient than other existing interactive lighting solutions.

According to one embodiment of the invention, the method according to the invention comprises the steps of performing a rasterization process in order to produce a geometry frame buffer; Performing a visibility process of the tridimensional scene with regards to a set of lights defined in the scene in order to produce a shadow map; and wherein the geometry framebuffer, shading framebuffers are split into buckets corresponding to portions of the twodimensional image.

Indeed, the use of a geometry framebuffer can be very cumbersome when dealing with complex geometries. For a given complex 3D image, the size of the resulting geometry framebuffer file can be around 100 Gb, and cannot be generated and/or loaded all at once by one process. So in order to be able to generated and access data of that size, the geometry framebuffer file is split into a collection of smaller files which can be independently generated, loaded and discarded on demand by a client process.

According to one aspect of the invention, buckets are stored on persistent storage, and loaded in live memory when the corresponding image portion is to be processed.

The disk storage (hard drive) is used instead of the live memory (RAM) to cache the result of the computation of each process or sub process. The reason for this is that the RAM is limited in size, and is temporary memory limited to the life of one process. Using disk storage gives access to virtually unlimited and cheap memory resources for static caching of the information and ensures avoiding multiple computations of the same data.

Interactivity in the lighting process is improved by computing once for all, all the geometry fragments visible from a given point of view and put the result to disk.

According to another aspect of the invention, the rasterization, visibility and/or shading process are divided into subprocesses. According to a further aspect, the visibility process is performed independently for each light source.

According to another aspect of the invention, shader information is stored in a shading tree structure comprising a plurality of nodes and wherein the shader framebuffer is conceived for storing the results of the evaluation of a node from the shading tree structure.

Caching of results of shading nodes calculation limit re-evaluation needs on modifications. Indeed for each fragment of the geometry framebuffer is mapped with the result of the evaluation of the corresponding fragment in a given shader and generates a custom framebuffer for this shader only to cache its evaluation state.

According to another aspect of the invention, only sub-regions of the image are processed while in the shading process.

Such mechanism can be called the “region of interest” of the rendered image. It is constituted of a sub-portion of the full image to limit the computation of the image to the specified region. This method is using only the appropriate precomputed buckets from the cached geometry, shadow and shader framebuffers, allowing optimal rendering of the portion of the image loading only a minimal amount of data.

According to another aspect of the invention, the geometry framebuffer comprises additional information for interactive control of the scene file or for non rendering related use, such as additional scene description information to be used to navigate through the components of the scene from a final rendered image view.

According to a further aspect of the invention, geometry frame buffer is adapted for dynamic extension.

According to a further aspect of the invention, the shader framebuffer is suitable for storing of additional information for use by the shaders.

These types of data can be of any kind, and not just geometric information. Each shader in the shader tree can then use this to store specialized precomputing data that can help it speed up its final computation.

The present invention also concerns a system for implementing a method as mentioned above, comprising a central processing unit but also a computer program product implementing said method and a storage medium comprising source code or executable code of a computer program implementing said method.

Methods and devices that implement the embodiments of the various features of the invention will now be described with reference to the drawings.

### BRIEF DESCRIPTION OF THE DRAWINGS

FIG. 1 is a schematic view of an hardware architecture used in connection with the method according to the present invention.

FIG. 2 is a schematic view of a rendering architecture.

FIG. 3 is a schematic view of a rendering architecture including the caching structure used in the invention.

FIG. 4 is a schematic diagram of a method according to the invention.

FIG. 5 is a schematic diagram illustrating the caching and reusing of the result of a shader evaluation.

### DETAILED DESCRIPTION

The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements.

The following description is provided to enable any person skilled in the art to make and use the invention and sets forth the best modes contemplated by the inventor, but does not limit the variations available.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known methods and techniques may not be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc.

The term “data element” refers to any quantum of data packaged as a single item. The term “data unit” refers to a collection of data elements and/or data units that comprise a logical section. The term “storage database” includes any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

In general, the terms “data” and “data item” as used herein refer to sequences of bits. Thus a data item may be the contents of a file, a portion of a file, a page in memory, an object in an object-oriented program, a digital message, a digital scanned image, a part of a video or audio signal, or any other entity which can be represented by a sequence of bits. The term “data processing” herein refers to the processing of data items, and is sometimes dependent on the type of data item being processed. For example, a data processor for a digital image may differ from a data processor for an audio signal.

In the following description, certain terminology is used to describe certain features of one or more embodiments of the invention.

The term “bucket” refers to a data unit that is stored with an associated key for rapid access to the quantum of data. Such as, for example, a bucket can consist of a block of memory that is subdivided into a predetermined number of smaller blocks of uniform size, each of which is an allocatable unit of memory. The terms “stream,” “streamed,” and “streaming” refers to the transfer of data at a steady high-speed rate sufficient to ensure that enough data is being continuously received without any noticeable time lag.

The term “shading” refers to the effects of illumination upon visible (front facing) surfaces. When a 3D scene is rendered, the shading is combined with the reflected light, atmosphere, and camera information to compute the final appearance of the inside and outside surface colors for a 3D scene.

The term “UV mapping” refers to a 3D modeling process of making a 2D image representing a 3D model. The UV map transforms the 3D object onto an image known as a texture.

The term “noise” refers to pseudo random, unwanted, variations in brightness or color information inducted into an image. Image noise is most apparent in image regions with low signal level, such as shadow regions.

The term “sampling techniques” refer to a statistical practice that uses measured individual data points to statistically infer, or predict, other non-observed data points based on the observed data points.

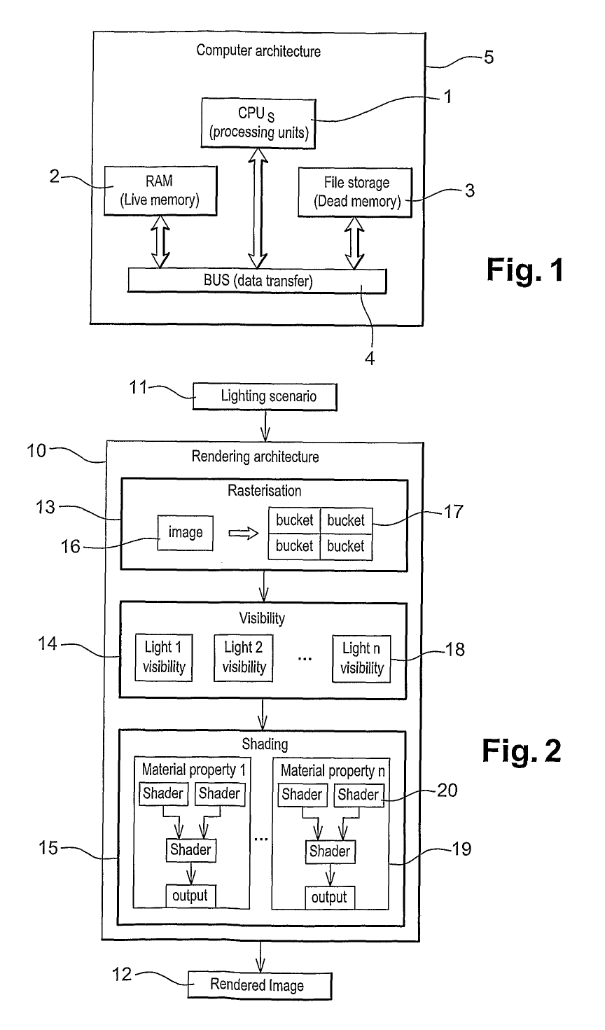

As described in FIG. 1: the method according to the invention may be implemented using a standard computer architecture 5 comprising a Central Processing Unit or CPU 1 composed of one or many cores, accessing data through a BUS 4 and storing data either temporarily in a Random Access Memory unit 2 or permanently on a file system 3.

A system according to the invention was tested on two different types of computers: A HP xw6600 graphic workstation (2 Intel Xeon CPU quad core 2.84 Ghz, 8 Gb RAM DDR2, 160 Gb 10,000 rpm hard drives), and a HP Elitelook 8730w laptop computer (1 Intel Core 2 extreme CPU 2.53 Ghz, 8 Gb RAM DDR2, 320 Go 7,200 rpm hard drive).

Referring to FIG. 2, a rendering architecture 10 is a system taking a lighting scenario of a 3D Scene as input 11 and generating a final image as output 12. The rendering architecture 10 comprises three main units performing three distinct processes.

First process is a rasterisation process 13, wherein the geometry complexity of the 3D Scene is converted into camera space depending of the resolution of the final image.

Second process is a visibility process 14, wherein the geometry complexity of the 3D Scene is processed from the point of view of the lights, in order to determine the corresponding shadows.

Third Process is a shading process 15, wherein the final color of a given pixel is determined by evaluating how the materials applied to the geometry visible from this pixel reacts to light.

Each process can be divided into sub-processes as described below.

The rasterisation process 13 is applied to a rectangular area representing the final image 16. This process can be split into sub processes by dividing the computation of the geometry complexity in image space into sub images named buckets 17.

A bucket is a portion of a framebuffer, a fragment is the atomic entity in the framebuffer or bucket. A fragment would correspond to a pixel if there is no antialiasing for example.

The visibility process 14 can be independently applied to each light 18 of a lighting scenario 11 of a 3D scene.

The shading process 15 can be applied independently for each pixel and for each object of the lighting scenario used to described a material property 19. Considering a material architecture using a graph of connected material operators commonly called shaders to represent the properties of each material, each shader 20 may be computed independently from the other.

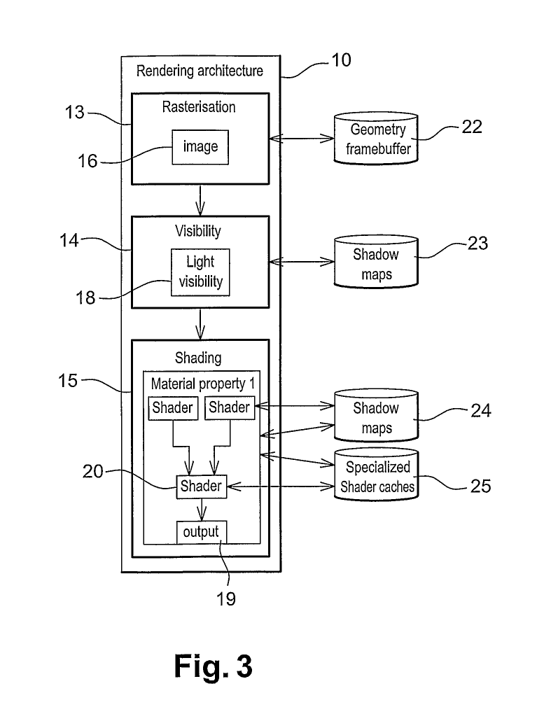

Now referring to FIG. 3, the caches or storage entities used in the above described rendering architecture 10 are identified.

A geometry framebuffer cache 22 resulting from the rasterisation process 13 in image space 16, a shadow map cache 23 resulting from the visibility process 14 for each light 18 of the lighting scenario of the 3D Scene, a generic shader framebuffer cache 24 used to cache the state of any shader 20 and material property 19 of the shading process 15, with the option for some shaders to generate more specialized cache 25 on a case per case basis.

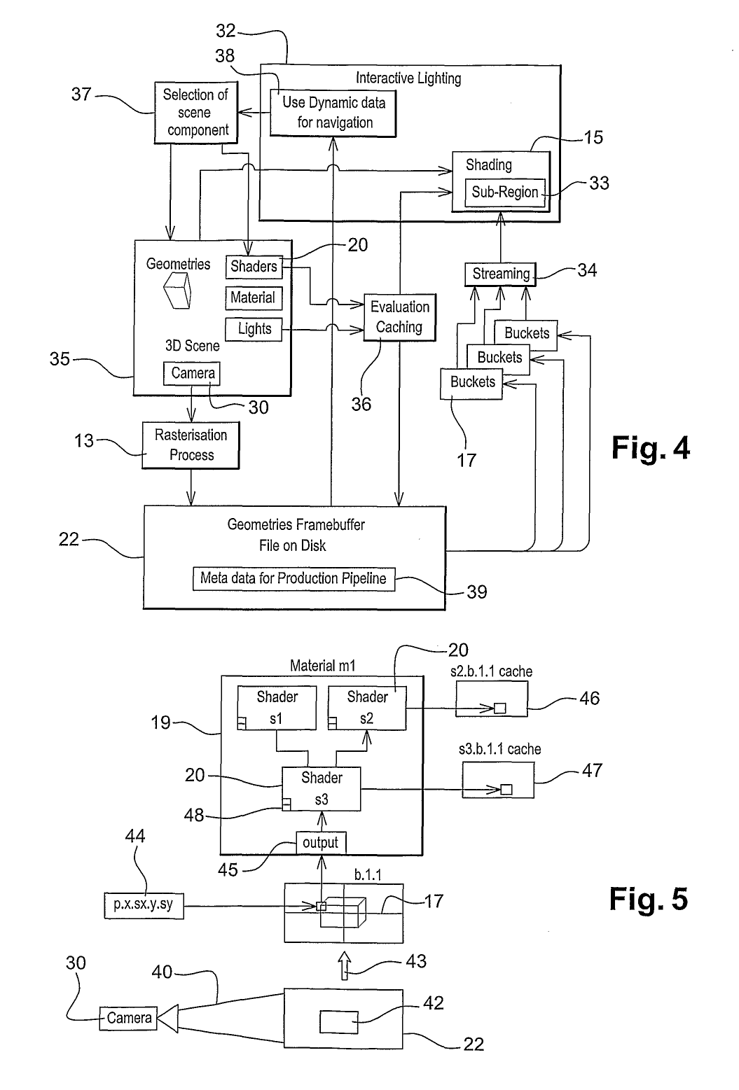

Referring now to FIG. 4, there is shown a diagram of the steps of a method for lighting a 3D scene that decreases the rendering time experienced by a user when lighting complex 3D scenes when any 3D parameters are changed and providing interactive feedback according to one embodiment of the present invention.

The method comprises a step of storing complex geometric calculations into a geometry framebuffer file 22 on disk.

This file will be generated by storing the result of a rasterization process 13 for an already defined camera 30.

When performing the shading 15 in the interactive re-lighting session 32, a selection of the subregion 33 of the image or portion of the scene to be shaded or reshaded is performed corresponding to a change in a portion of the scene 35.

Depending on the subregion being shaded 33, only the required data will be streamed 34 in memory and then discarded, using the bucket 17 representation of the geometry framebuffer File 22. In more detail, according to an example, a single bucket of the selected portion of the 3D scene is loaded into a memory. Then, the shading of the selected portion of the 3D scene is performed. Once this shading is performed, the memory is cleared. Then, the next bucket of data of the selected portion of the 3D scene is processed. The steps of loading and clearing are repeated until the shading is applied to the portion of the 3D scene to be manipulated

This approach avoids loading the whole geometry framebuffer file in memory.

The evaluation state 36 of each shader 20 is cached under a geometry framebuffer file representation 24 in order to re-shade only the modified shaders and their dependencies, and reloading the prior shader state from disk on next update.

Turning now to FIG. 5, the process of shader evaluation results caching and reusing is described in more detail.

A shader 20 is an object used to compute the properties of a given material associated to a given geometry in a 3D scene. When lighting a 3d scene, the final rendered image is computed from the point of view of a camera 30.

The camera 30 is defining the projection 40 used to transform 3D geometries 42 into image space or geometry framebuffer 22, this geometry framebuffer describing for each sub-pixel all the geometry fragments visible under the given sub-pixel. Each sub pixel is identified by pixel coordinates x, y and subpixel coordinates sx, sy.

As described previously, when rasterising the 3D scene, the framebuffer is split 43 into logical buckets 17, each bucket representing a set of fragments of the image.

During the shading process 15, when shading the fragments under a subpixel 44 of a given bucket 17, the material 19 associated to that fragment will be evaluated 45, triggering the evaluation of a shader s3 20, itself trigerring the evaluation of another shader s2 20 and storing the final result of this evaluation (usually under the form of an array of 4 double precision values for red/green/blue/alpha channels) into a file structure following the same organisation as the geometry framebuffer, that is, one cache file per bucket 46, 47 and one value per fragment. Note that each shader will perform the same task of storing the result of its own evaluation into its own shader cache file.

Now when modifying one of the input parameters 48 of the shader s3, looking at the dependencies, the final material m1 19 will need to be recomputed and the cache for shader s3 47 will be invalidated, but shader s2 not depending on this modification will not be affected and will keep its cache 46 clean for future evaluation.

Then, when reshading the image 22 after modification of s3's parameter 48, the shading of the fragments under a given sub pixel 44 will trigger again the evaluation of Material ml 19 itself trigerring the evaluation of shader s3 20, which cache is invalid, itself trigerring evaluation of shader s2 20, which evaluation will be skipped since the cache is valid and the resulting value will directly be read from the shader cache file for the given fragment.

The geometry framebuffer file approach can be used to store the result of any node of the shading tree instead of just the leaf node currently represented by the Camera. Therefore, any node can use its cache to skip its re-evaluation when a parameter it does not depend on is changed in the shading tree. This way, only the shading nodes after the changed node in the shading tree need to be recomputed. The prior node computations in the shading tree are already stored and do not need to be changed, unlike the current related art that would recalculate the entire shading tree. Because a typical 3D scene contains thousands of shading nodes, re-computing only a dozen nodes while storing the remaining node can increase the interactive rendering speed by a factor of up to 100 times.

The method further comprises steps for using the shading tree node caching to improve rendering quality.

The present method also improves the quality of the 3D scene rendering. For example, currently most of the shadows in a 3D scene are computed through sampling techniques. These sampling techniques create noise. To diminish the noise a common approach is to increase the number of samplings, therefore the computation time. Since the shadowing information is cached in the geometry framebuffer file the “virtual” cached image can be filtered to diminish noise without the computing time usually required to do so.

In another embodiment, the geometry framebuffer file can be dynamically extended, that is, other types of information, such as, for example, the results of a computation or an index to external information, not just the complex geometric calculations, regarding the 3D scene can be stored. For example, a color per pixel, a parametric UV mapping, a texture UV mapping, index to the name of a character, a computation time, or an index to the most intense light among other types of information that can be stored in the storage.

In another embodiment, the geometry framebuffer file approach can be used to provide specialized user interface displays for the user that is customized for maximum efficiency. For example, the specialized user interface display can provide interactive geometry, materials, lights or name of animators who worked on the character, and the version of the animation for the character, among other information, can be displayed and selected from the specialized user interface display. Additionally, any relevant information to the workflow can also be presented in a more efficient specialized user interface display increasing the productivity of the user and reducing the resources necessary to produce a completed 3D scene.

As can be seen on FIG. 4, storage of extra information may be provided for interactive control of the 3D scene like selection 37 of scene component from the rendered image window 38 or leveraging from storing generic information 39 on a per pixel basis in the geometry framebuffer file to reference production pipeline data.

For this purpose, geometry framebuffer file index information (meta-data) can be stored for a rendered 3D character or a 3D scene that can include production information. For example, after a 3D character or the 3D scene is completely rendered, meta-data information relevant to the character, such as, for example, version, rendering time, who worked on it, name of the character, can be stored and indexed for retrieval during the production process. This provides the capability for a user to select the 3D character or the 3D scene at any point in the production process and interactively access and display the information related to the 3D character or 3D scene.

Each computation step can be automatically triggered by the rendering engine as it usually is or manually activated/deactivated by the user. Indeed, the user can decide whether or not to recompute the geometry framebuffer, the shadow maps, the shaders. Additional to this the user can explicitly deactivate the evaluation of a given shader or freeze it and force it to use the cache of the previous computation. The goal is to avoid expensive computation that the user could assume to be useless.

For example, in the case of a scene with reflection, the reflection of the scene will be performed by a ray-trace light. The reflection computation can be very slow since it might need to process the whole scene geometry. This raytraced light can be freezed to speed up the final image computation while modyfing other lighting parameters of the scene. Even if the final image is not the correct one since the modifications can affect the reflection, these differences might not necessarily matter to the artist in a given context.

In conclusion, the decision on what is important to artisticly judge if an image is correct depends on subjective human parameters that the software cannot smartly guess. We are proposing a system where the artist can tailor the lighting process to adapt it to its own methodology and ensure maximum flexibility when performing its artistic task.

Although the present invention has been described with a degree of particularity, it is understood that the present disclosure has been made by way of example. As various changes could be made in the above description without departing from the scope of the invention, it is intended that all matter contained in the above description or shown in the accompanying drawings shall be illustrative and not used in a limiting sense.

1. Method for rendering or interactive lighting of a tridimensional scene in order to obtain a two dimensional image of said scene comprising:
performing a shading process taking into account a set of shader and material properties of the 3D objects of the scene;
wherein the shading process produces a shader frame_buffer used to store information records related to shaders and/or material properties of the tridimensional scene in a format where said information records can be accessed in relation with a an image position in the two-dimensional image.

2. Method according to claim 1, further comprising
performing a rasterization process in order to produce a geometry frame buffer;
performing a visibility process of the tridimensional scene with regards to a set of lights defined in the scene in order to produce a shadow map; and
wherein geometry framebuffer and/or the shading frame_buffer_ are split into buckets or fragments corresponding to portions of the two-dimensional image.

3. Methods according to claim 2, wherein buckets or fragments are stored on persistent storage, and loaded in live memory when the corresponding image portion is to be processed.

4. Method according to claims 2, wherein a rasterization, visibility and/or shading process are divided into subprocesses.

5. Method according to claim 1 wherein shader information is stored in a shading tree structure comprising a plurality of nodes and wherein the shader frame_buffer is conceived for storing results of the evaluation of a node from the shading tree structure.

6. Method according to claim 1, wherein only sub-regions of the image are processed while in the shading process.

7. Method according to claim 1, wherein the geometry frame_buffer comprises additional information for interactive control of the scene or for non rendering related use, such as additional scene description information to be used to navigate through components of the scene from a final rendered image view.

8. Method according to claim 1, wherein the geometry frame buffer is adapted for dynamic extension.

9. Method according to claim 1, wherein the shader frame_buffer is suitable for storing of additional information for use by the shaders.

10. Method according to claim 1, wherein the visibility process is performed independently for each light source.

11. System for implementing a method according to claim 1, comprising a central processing unit and disk.

12. Computer program product implementing a method according to claim 1.

13. Storage medium comprising source code or executable code of a computer program according to claim 12.
